(19) United States
(12) Patent Application Publication
(10) Pub. No.: US 2015/0333418 A1
(43) Pub. Date: Nov. 19, 2015

(54) Contact Sealing Ring, Electrical Contact Point And Method For Contacting Electrically Conductive Components

(71) Applicant: Airbus Operations GmbH, Hamburg (DE)

(72) Inventors: Jürgen Otten, Hamburg (DE); Axel Kranich, Hamburg (DE); Wilfried Bauch, Hamburg (DE); Günther Stöckmann, Hamburg (DE)

(73) Assignee: Airbus Operations GmbH, Hamburg (DE)

(21) Appl. No.: 14/707,154

(22) Filed: May 8, 2015

(30) Foreign Application Priority Data
May 15, 2014 (DE) 10 2014 209 259.0

(51) Int. Cl. H01R 4/30; H01R 43/26; H01R 13/52; H01R 4/64; H01R 13/22; H01R 4/34

(52) U.S. Cl. CPC H01R 4/304; H01R 13/22; H01R 4/34; H01R 13/5219; H01R 4/64; H01R 43/26

(57) ABSTRACT

A contact sealing ring includes an electrically conductive annular disc which has a central through-opening, a first electrically conductive contact formation which protrudes from a first side of the annular disc, and a second electrically conductive contact formation which protrudes from a second side, opposite the first side, of the annular disc.

### FIELD OF THE INVENTION

The present invention relates to a contact sealing ring, to an electrical contact point, and to a method for contacting electrically conductive components.

### BACKGROUND OF THE INVENTION

Mechanical and electrical component part assemblies are often held together by means of riveted or screwed connecting elements. For this purpose, eyelets or contact tabs are mostly used to electrically connect cables and current-carrying components to component parts having a greater surface area.

U.S. Pat. No. 3,626,357 A discloses a connecting disc having outwardly pointing protrusions which, when screwed into a metal component, engage in the surface of said component and provide an electrically conductive connection between the disc and the component.

DE 31 14 300 C1 discloses an electrically conductive sealing disc having an annular inner part and an annular sheathing. The inner part has a plurality of tooth-like noses which project from the surface of the inner part and emerge from the disc surface, defined by the sheathing, when axial pressure is exerted.

### BRIEF SUMMARY OF THE INVENTION

There is a need, however, for solutions to allow two or more electrically conductive components to be contacted in a manner that is reliable, wear-resistant, durable and optimal in terms of electrical conductivity.

Therefore, according to a first aspect, the invention provides a contact sealing ring comprising an electrically conductive annular disc having a central through-opening, a first electrically conductive contact formation protruding from a first side of the annular disc, and a second electrically conductive contact formation protruding from a second side, opposite the first side, of the annular disc.

According to a second aspect, the invention also provides an electrical contact point comprising a first electrically conductive component having an electrical contact surface, at least one second electrically conductive component having an electrical contact surface facing the electrical contact surface of the first electrically conductive component, and at least one contact sealing ring according to the first aspect of the invention, which is arranged between the electrical contact surface of the first electrically conductive component and the electrical contact surface of the second electrically conductive component.

According to a third aspect, the invention further provides a method for contacting electrically conductive components, comprising the steps of arranging a contact sealing ring, which comprises an electrically conductive annular disc having a central through-opening, an outer sealing ring arranged along an outer circumference of the annular disc, a first electrically conductive contact formation protruding from a first side of the annular disc, and a second electrically conductive contact formation protruding from a second side, opposite the first side, of the annular disc, above a first electrically conductive component, arranging a second electrically conductive component, which has a through-opening, above the contact sealing ring such that the through-opening in the second electrically conductive component is arranged concentrically with the through-opening in the contact sealing ring, guiding a bolt through the through-opening in the second electrically conductive component and the through-opening in the contact sealing ring, and applying a connecting force, directed axially with respect to the bolt, to the first electrically conductive component, the second electrically conductive component and the contact sealing ring such that the outer sealing ring seals the inner region around the through-opening in the contact sealing ring between the first electrically conductive component and the second electrically conductive component in a liquid-tight manner.

The basic advantages of the aspects according to the invention are that electrical contact resistances at electrical contact points are low and remain low in the long term. This can be achieved in that the regions in contact with the contact sealing rings according to the invention are considerably better defined. In addition, the contact regions can be defined in a reliable and reproducible manner, even when assembling components in tight, difficult to access connection regions that are not visible from the outside.

The reliable and durable outward sealing of the contact regions allows the contact sealing rings according to the invention to ensure that oxidation, corrosion, and material migration caused by electrolysis are kept to a minimum in the region of the electrical contacts. Furthermore, the integral design of the contact ring with the seal sheathing allows additional sealing materials such as sealing foam, sealing paint or varnish to be omitted, or at least to reduce the required amount thereof to a minimum. This also means that undesirable deteriorations in the electrical contact points owing to cracking paint occur less frequently, the weight of the system as a whole is reduced, and less time has to be spent on repair and maintenance work.

The solutions according to the invention for forming electrical contact points are particularly advantageous for the motor vehicle industry and the aeronautics and astronautics sectors since the requirements for low contact resistances will become ever greater in the future as a result of the wide use of carbon fibre materials.

According to one embodiment of the contact sealing ring according to the invention, the contact sealing ring can further comprise an outer sealing ring which is arranged along an outer circumference of the annular disc.

According to one embodiment of the contact sealing ring according to the invention, the contact sealing ring can further comprise an inner sealing ring which is arranged around the through-opening on an inner circumference of the annular disc.

According to a further embodiment of the contact sealing ring according to the invention, the outer sealing ring and/or the inner sealing ring can have a thickness which is greater than the thickness of the annular disc.

According to a further embodiment of the contact sealing ring according to the invention, the outer sealing ring and/or the inner sealing ring can comprise a resilient and liquid-tight material.

According to a further embodiment of the contact sealing ring according to the invention, the first contact formation and the second contact formation can both be annular, raised portions extending concentrically with the annular disc. In this context, according to a further embodiment, the circular path radius of the first contact formation can be greater than the circular path radius of the second contact formation.

According to a further embodiment of the contact sealing ring according to the invention, the first contact formation and the second contact formation can both be curved, raised circular path portions extending concentrically with the annular disc.

According to a further embodiment of the contact sealing ring according to the invention, the first contact formation and the second contact formation can both be structural patterns formed on the sides of the annular disc in a protruding manner.

According to a further embodiment of the contact sealing ring according to the invention, the first contact formation and the second contact formation can both be undulating circular paths formed on the sides of the annular disc in a protruding manner.

According to one embodiment of the contact point according to the invention, the second electrically conductive component can have a through-opening arranged concentrically with the through-opening in the contact sealing ring.

According to a further embodiment of the contact point according to the invention, the contact point can further comprise a bolt which is guided through the through-opening in the second electrically conductive component and the through-opening in the contact sealing ring.

According to a further embodiment of the contact point according to the invention, the first electrically conductive component can be a metal plate, a stud bolt or an earth bar.

According to a further embodiment of the contact point, the second electrically conductive component can be a cable lug or a metal plate.

### BRIEF DESCRIPTION OF THE DRAWINGS

In the following, the invention will be described in connection with and with reference to the embodiments given by way of example and shown in the accompanying drawings.

The accompanying drawings give a better understanding of the present invention, and illustrate variants of the invention by way of example. They are used to illustrate principles, advantages, technical effects and possible variations. Naturally, other embodiments and many of the intended advantages of the invention are also conceivable, in particular in view of the detailed description of the invention in the following. The elements in the drawings are not necessarily shown to scale, and are shown in a simplified form or schematically in some cases for reasons of clarity. Like reference numerals denote like or equivalent component parts or elements.

FIG. 1 is a schematic view from below and a schematic plan view of a contact sealing ring according to an embodiment of the invention;

FIG. 2 is a schematic view of a contact sealing ring according to FIG. 1 in the cross section C-C′, according to an embodiment of the invention;

FIG. 3 is a schematic view of an electrical contact point according to a further embodiment of the invention;

FIG. 4 is a schematic view of an electrical contact point according to a further embodiment of the invention;

FIG. 5 is a schematic view of an electrical contact point according to a further embodiment of the invention;

FIG. 6 is a schematic view of an electrical contact point according to a further embodiment of the invention; and

FIG. 7 is a schematic view of the steps of a method for contacting electrically conductive components according to a further embodiment of the invention.

### DETAILED DESCRIPTION

Although specific embodiments are disclosed and described herein, it is clear to a person skilled in the art that a wide range of further, alternative and/or equivalent implementations of the embodiments can be selected without substantially deviating from the basic concept of the present invention. In general, any variations on, modifications to and alterations to the embodiments disclosed herein should also be considered to be covered by the invention.

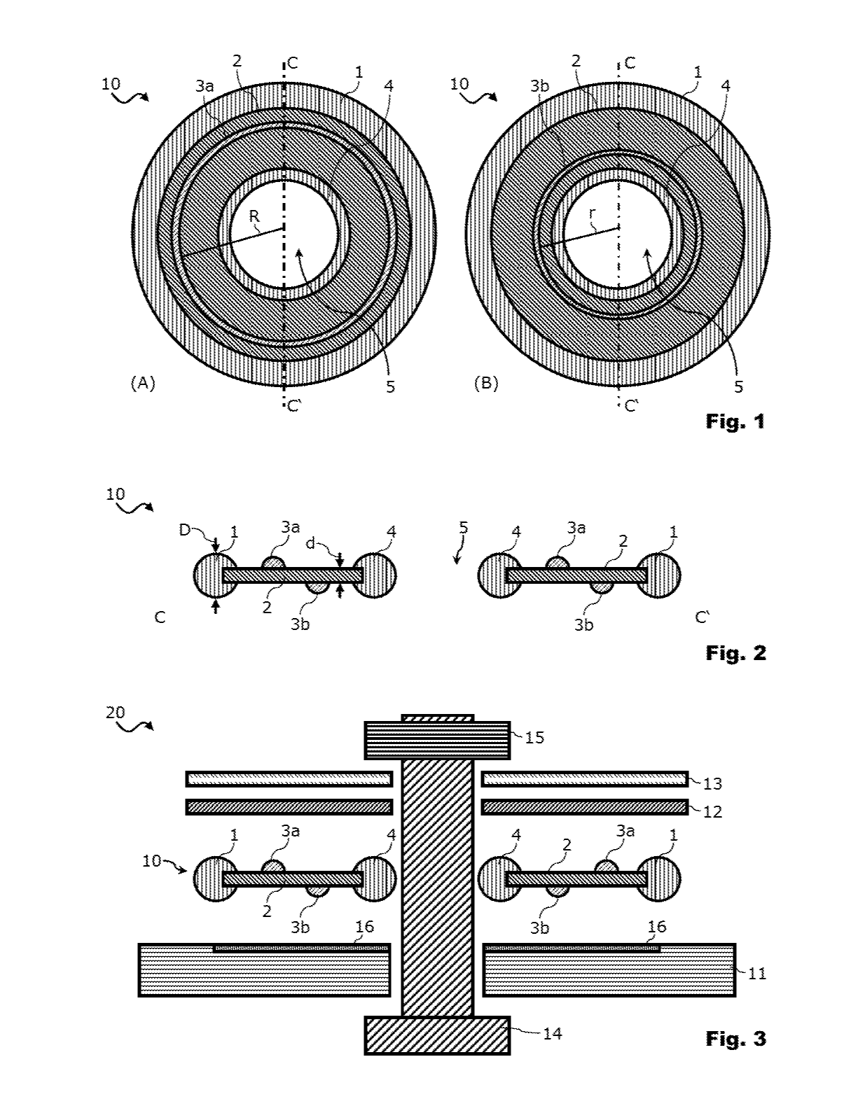

FIG. 1 is a schematic plan view (A) and a schematic view from below (B) of a contact sealing ring 10. In this context, the contact sealing ring 10 is generally in the shape of a ring. In this regard, FIG. 2 is a schematic sectional view of the contact sealing ring 10 along the sectional line C-C′ indicated by a dash-dot line in FIG. 1.

The ring is formed from an annular disc 2 which is made of electrically conductive material and has a gap or through-opening 5 in the middle. The electrically conductive material of the annular disc 2 can, for example, be a metal such as aluminium, bronze, brass, copper, iron, nickel, steel or titanium. The annular disc 2 can also be coated with an electrically conductive material, such as zinc or chromium.

An outer sealing ring 1, for example made of vulcanised rubber, unvulcanised rubber, polytetrafluoroethylene (PTFE), polyethylene (PE) or similar resilient materials is arranged on the outer edge of the annular disc 2. The outer sealing ring 1 is arranged along an outer circumference of the annular disc 2. An inner sealing ring 4, which can likewise consist of vulcanised rubber, unvulcanised rubber, PTFE, PE or similar resilient materials, can similarly be arranged on an inner circumference of the annular disc 2, i.e. on an outer circumference of the through-opening 5. The outer sealing ring 1 and the inner sealing ring can both have a thickness D which is greater than the thickness d of the annular disc 2. The outer sealing ring 1 and the inner sealing ring 4 are each used to seal the region of the annular disc 2 between the sealing rings 1 and 4 in a liquid-tight manner from the external environment, in particular when the contact sealing ring 10 is mounted between two planar components. The outer sealing ring 1 and the inner sealing ring 4 can in each case be mounted, glued, vulcanised or attached in a different manner to the circular side edges of the annular disc 2. In this case, the outer sealing ring 1 and the inner sealing ring 4 can each comprise groove-shaped recesses along their inner circumference or outer circumference, respectively, the annular disc 2 being inserted into said recesses. Alternatively, the outer sealing ring 1 and the inner sealing ring 4 can also be fixed to the outer circumference of the annular disc 2 by means of a suitable joining method, for example by vulcanisation.

First and second electrically conductive contact formations 3a and 3b are arranged on each side of the annular disc 2. Both contact formations project from a respective side of the annular disc 2. In FIG. 1, the first contact formation 3a and the second contact formation 3b are both shown as circular raised portions extending concentrically with the annular disc 2. In this case, the circular path radius R of the first contact formation 3a is greater than the circular path radius r of the second contact formation 3b. The raised portions can have a ridge-shaped or dome-shaped cross section, as shown in FIG. 2.

It goes without saying, however, that other shapes and structures than those shown by way of example in FIG. 1 are also possible for the contact formations 3a and 3b. For example, the first contact formation 3a and the second contact formation 3b can each be curved, raised circular path portions which extend concentrically with the annular disc 2 and are broken in some portions along the full circular path. For example, three raised circular arcs, which each have a central angle of 60° and are distributed over the circumference of the annular disc 2, can be provided in each case for the first contact formation 3a and the second contact formation 3b. It may also be possible as an alternative to form the first contact formation 3a and the second contact formation 3b in each case as structural patterns formed on the sides of the annular disc 2 in a protruding manner, for example as spherical domes arranged in a uniform manner along the sides of the annular disc 2. Lastly, it is also possible to form the first contact formation 3a and the second contact formation 3b in each case as undulating circular paths formed on the sides of the annular disc 2 in a protruding manner, i.e. as undulated circular paths of which the circular path radius varies cyclically between a minimum value and a maximum value around the ring circumference.

Owing to the first contact formation 3a and the second contact formation 3b, an electrical contact is established between the annular disc 2 and a planar electrically conductive component placed on the respective side of the contact sealing ring 10. By applying a force that is parallel to the surface normal of the annular disc 2 or the contact sealing ring 10, two electrically conductive components positioned on the opposite sides of the contact sealing ring 10 can be pressed onto the contact sealing ring 10 such that the resilient material of the outer sealing ring and optionally of the inner sealing ring 4 is squashed. Internal tensions are created in the annular disc 2 as a result, and these press the contact formations 3a and 3b in each case onto the contact surfaces of the respective electrically conductive components. This approach forms reliable electrical contact regions between the annular disc 2 and the electrically conductive components, which contact regions are protected from external contamination, such as corrosion, oxidation, infiltration of foreign particles or the like, by the electrically conductive components themselves, the outer sealing ring 1 and possibly by the inner sealing ring 4. Material shrinkage, which can cause the contact pressure to drop over time, is largely compensated for by the internal tensions created in the annular disc 2, such that the electrical contact regions are provided with an electrical contact resistance which is consistently low in the long term.

Electrical currents between the electrically conductive components to be connected are borne only by the contact sealing ring 10. Loose connections which can be triggered by temperature variations, vibrations or material distortion are prevented by the internal tensions in the contact sealing ring 10. The contact regions are sealed from the outside environment in a gas-tight and liquid-tight manner, even in adverse assembly conditions. Moreover, maintenance and repair work are made simpler since the electrical contact points can be mounted on or removed from the contact sealing ring 10 in a simple and reversible manner.

In the process, time does not have to be spent waiting for sealing paints to dry.

FIGS. 3, 4, 5 and 6 are schematic exploded sectional views of example electrical contact points 20, 30, 40 and 50. In this case, with the electrical contact points 20, 30, 40 and 50, one or more contact sealing rings can be used, more particularly contact sealing rings 10 as described in connection with FIGS. 1 and 2.

The electrical contact point 20 in FIG. 3 is a cable lug contact point, in which an electrically conductive planar component 11 is provided with a contact surface 16. In this case, the component 11 can for example be a metal component, for example made of aluminium, steel, copper or titanium. Here, the contact surface 16 can for example be a milled, polished or ground surface of the component 11 that functions as an electrical contact region. The cable lug 12 is provided with a through-opening which is arranged concentrically with the through-opening 5 in the contact sealing ring 10. In the process, the contact sealing ring 10 is arranged between the component 11 and the cable lug 12 such that the through-opening 5 in the contact sealing ring 10 comes to rest concentrically with a through-opening in the component 11.

A bolt, for example a screw 14, which is secured on the upper side of the cable lug by means of a washer 13 and a nut, is guided through the through-openings in the component 11, the contact sealing ring 10 and the cable lug 12. By fixing the nut 15 on the thread of the screw 14, a contact force extending axially with respect to the screw 14 is produced and presses the cable lug 12 and the component 11 onto the contact sealing ring 10. As explained above, the contact sealing ring 10 provides a reliable, durable electrical contact between the component 11 and the cable lug 12 that has a consistently low contact resistance.

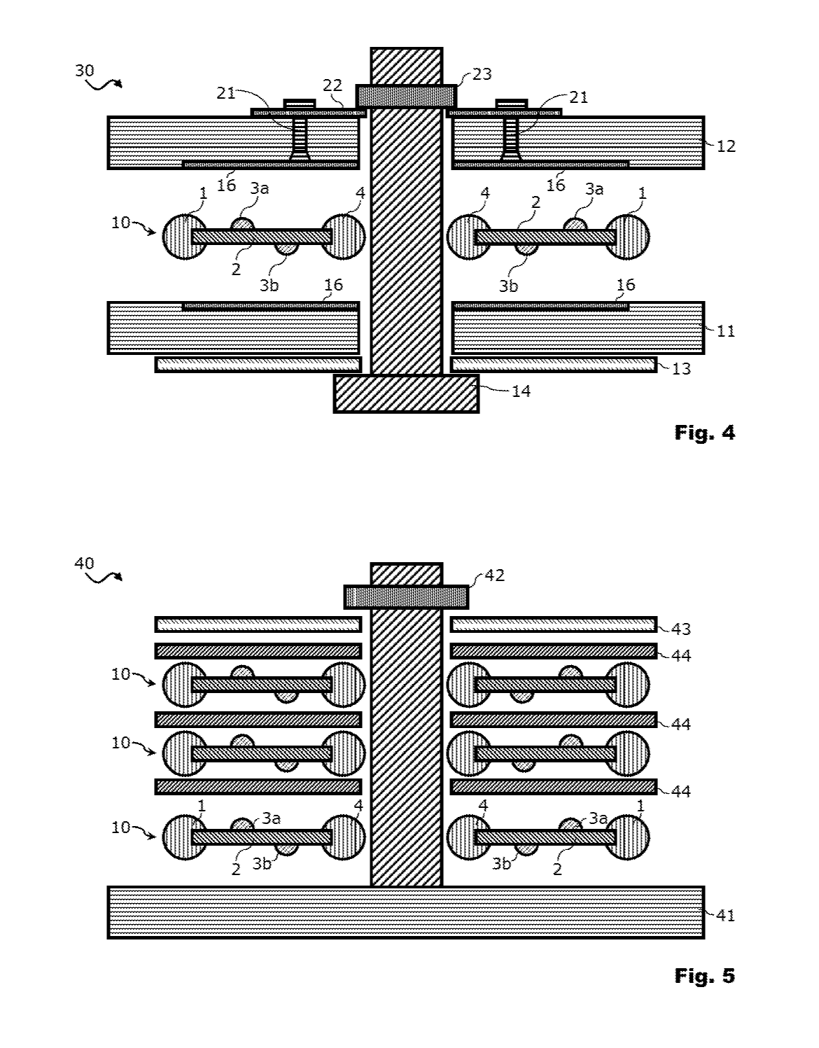

FIG. 4 shows a rivet nut contact point 30, in which the cable lug 12 is pressed onto the contact sealing ring 10 by means of rivets 21, which are guided through the cable lug 12 and rivet flanges 22, and a rivet nut 23.

FIG. 5 is a schematic view of a stud bolt distributor 40, in which a threaded rod of a stud bolt 41 is guided through the through-opening 5 in the contact sealing ring 10 and through-openings in a plurality of cable lugs 44. A contact sealing ring 10, which in each case provides an electrical contact between adjacent components when a stud bolt nut 42 is screwed onto the threaded rod, is introduced in each case between the lower flange of the stud bolt 41 and the lowermost cable lug 44 and between each two cable lugs 44 positioned further upwards. A locking washer 43, for example a Nord-Lock® locking element, can also be introduced between the stud bolt nut 42 and the uppermost cable lug 44.

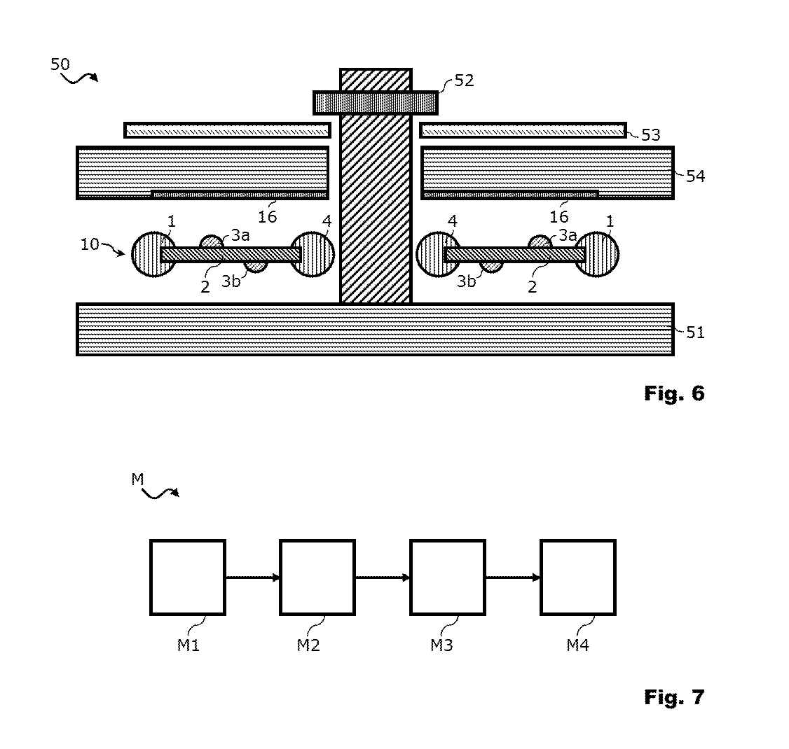

Lastly, FIG. 6 is a schematic view of an earth bar contact point 50 comprising an earth bar 51 having a lower flange and a threaded rod. The threaded rod is guided through the through-opening 5 in the contact sealing ring 10 and a through-opening in an electrically conductive component 54, for example made of aluminium. The threaded rod of the earth bar 51 is secured to an earth bar nut 52 by means of a washer 53.

FIG. 7 is a block diagram of a method M for electrically contacting electrically conductive components, for example for forming an electrical contact point as in FIG. 3, 4, 5, and/or 6. For this purpose, use can be made of a contact sealing ring 10 as described in connection with FIGS. 1 and 2.

In a first step M1, a contact sealing ring 10, which comprises an electrically conductive annular disc 2 having a central through-opening 5, an outer sealing ring 1 arranged along an outer circumference of the annular disc 2, a first electrically conductive contact formation 3a protruding from a first side of the annular disc 2, and a second electrically conductive contact formation 3a, protruding from a second side, opposite the first side, of the annular disc 2, is arranged above a first electrically conductive component. In a second step M2, the second electrically conductive component, which has a through-opening, is arranged above the contact sealing ring 10 such that the through-opening in the second electrically conductive component is arranged concentrically with the through-opening 5 in the contact sealing ring 10.

In step M3, a bolt is guided through the through-opening in the second electrically conductive component and the through-opening 5 in the contact sealing ring 10 such that in a step M4, a connecting force directed axially with respect to the bolt can be applied to the first electrically conductive component, the second electrically conductive component and the contact sealing ring 10, for example by placing and screwing a nut onto an external thread of the bolt. As a result, the outer sealing ring 1 seals the inner region around the through-opening 5 in the contact sealing ring 10 between the first electrically conductive component and the second electrically conductive component in a liquid-tight manner.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A contact sealing ring comprising:
an electrically conductive annular disc having a central through-opening;
a first electrically conductive contact formation protruding from a first side of the annular disc; and
a second electrically conductive contact formation protruding from a second side, opposite the first side, of the annular disc.

2. The contact sealing ring according to claim 1, further comprising:
an outer sealing ring arranged along an outer circumference of the annular disc.

3. The contact sealing ring according to claim 2, further comprising:
an inner sealing ring arranged around the through-opening on an inner circumference of the annular disc.

4. The contact sealing ring according to claim 1, wherein at least one of the outer sealing ring and the inner sealing ring has a thickness greater than the thickness of the annular disc.

5. The contact sealing ring according to claim 1, wherein at least one of the outer sealing ring and the inner sealing ring comprises a resilient and liquid-tight material.

6. The contact sealing ring according to claim 1, wherein the first contact formation and the second contact formation are both circular raised portions extending concentrically with the annular disc.

7. The contact sealing ring according to claim 6, wherein the circular path radius of the first contact formation is greater than the circular path radius of the second contact formation.

8. The contact sealing ring according to claim 1, wherein the first contact formation and the second contact formation are both curved, raised circular path portions extending concentrically with the annular disc.

9. The contact sealing ring according to claim 1, wherein the first contact formation and the second contact formation are both structural patterns formed on the sides of the annular disc in a protruding manner.

10. The contact sealing ring according to claim 1, wherein the first contact formation and the second contact formation are both undulating circular paths formed on the sides of the annular disc in a protruding manner.

11. An electrical contact point, comprising:
a first electrically conductive component having an electrical contact surface;
at least one second electrically conductive component having an electrical contact surface facing the electrical contact surface of the first electrically conductive component; and
at least one contact sealing ring, the contact sealing ring comprising:
an electrically conductive annular disc having a central through-opening;
a first electrically conductive contact formation protruding from a first side of the annular disc; and
a second electrically conductive contact formation protruding from a second side, opposite the first side, of the annular disc, wherein the at least one contact sealing ring is arranged
between the electrical contact surface of the first electrically conductive component and the electrical contact surface of the second electrically conductive component.

12. The electrical contact point according to claim 11, wherein the second electrically conductive component has a through-opening arranged concentrically with the through-opening in the contact sealing ring.

13. The electrical contact point according to claim 12, further comprising:
a bolt guided through the through-opening in the second electrically conductive component and the through-opening in the contact sealing ring.

14. The electrical contact point according to claim 11, wherein the first electrically conductive component is a metal plate, a stud bolt or an earth bar.

15. The electrical contact point according to claim 11, wherein the second electrically conductive component is a cable lug or a metal plate.

16. A method for contacting electrically conductive components, comprising:
arranging a contact sealing ring, the contact sealing ring comprising an electrically conductive annular disc having a central through-opening, an outer sealing ring arranged along an outer circumference of the annular disc, a first electrically conductive contact formation protruding from a first side of the annular disc, and a second electrically conductive contact formation protruding from a second side, opposite the first side, of the annular disc, above a first electrically conductive component;
arranging a second electrically conductive component, which has a through-opening, above the contact sealing ring such that the through-opening in the second electrically conductive component is arranged concentrically with the through-opening in the contact sealing ring;
guiding a bolt through the through-opening in the second electrically conductive component and the through-opening in the contact sealing ring; and
applying a connecting force, directed axially with respect to the bolt, to the first electrically conductive component, the second electrically conductive component and the contact sealing ring such that the outer sealing ring seals the inner region around the through-opening in the contact sealing ring between the first electrically conductive component and the second electrically conductive component in a liquid-tight manner.
